(19) United States
(12) Patent Application Publication
(10) Pub. No.: US 2021/0192441 A1
(43) Pub. Date: Jun. 24, 2021

(54) Goods IOT and System Based on Blockchain

(71) Applicant: Xuezhi Zhang, Guangzhou (CN)

(72) Inventor: Xuezhi Zhang, Guangzhou (CN)

(21) Appl. No.: 17/004,936

(22) Filed: Aug. 27, 2020

(30) Foreign Application Priority Data
Dec. 24, 2019 (CN) 201911360980.5

(51) Int. Cl. G06Q 10/08; G16Y 40/35; H04L 9/06; H04L 29/08; G16Y 20/40; G16Y 30/00; H04W 4/80

(52) U.S. Cl. CPC G06Q 10/0833; G06Q 10/0835; G06Q 10/087; G16Y 40/35; H04L 2209/38; H04L 67/12; G16Y 20/40; G16Y 30/00; H04W 4/80; H04L 9/0643

(57) ABSTRACT

The present invention discloses a goods IOT and system, where RFID readers installed at places or entrances and exits where goods pass including entrances and exits for roads, highways and expressways etc., entrances and exits of truck stations, railway stations and airports etc., entrances and exits of harbours and ports etc. and entrances and exits of warehouses, transit centers and transit warehouses etc. are connected to nodes of a blockchain to form an RFID reader blockchain to acquire data from passing goods with RFID tags; acquired datasets are asymmetrically encrypted, verified, packaged into a block with dataset acquired in the same period of time, written to the blockchain and synchronized in the chain and are therefore confidential, safe and incorrigible.

### CROSS REFERENCE TO RELATED APPLICATIONS

This application claims priority to Chinese Patent Application No. CN201911360980.5 filed on Dec. 24, 2019, which is incorporated herein by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is involved with network information system technology, and in particular, with the IOT and system for goods based on a blockchain.

The present inventor recently filed an application in China, Logistics Management Mode and System Based on Cloud Computing and IOT. The system is a big data platform for logistics management, gathering various goods consigners, goods consignees, logistics service providers, logistics operators, manufacturers, wholesalers and retailers etc. Logistics service providers and logistics operators etc. can operate like a big company on the platform. The intelligent logistics management platform can largely increase logistics efficiency; decrease logistics cost and provide low cost intelligent logistics service for manufacturing. The platform uses RFID tags for ID coding and tracking of goods. Goods circulating on the platform have detailed electronic tracking records. Blockchain technology can be used to increase the safety and incorrigibility of data during RFID data reading and transferring. The present invention introduces blockchain distributed network technology to construct an RFID reader network, forming an RFID reader blockchain distributed network as an IOT for goods.

### BRIEF SUMMARY OF THE INVENTION

The present inventor's earlier Chinese application discloses a logistics management system with sufficient RFID readers installed at various places where goods pass to track goods and cargoes with RFID tags. The present invention discloses an IOT (Internet Of Things) for goods based on a blockchain where sufficient RFID readers are installed at various places or entrances and exits where goods pass and connected to the nodes of a blockchain to collect data for passing goods with RFID tags so as to increase the safety and incorrigibility of data in dada acquisition and transmission. The various entrances and exits where goods pass include entrances and exits of roads, highways and expressways etc., entrances and exits of truck stations, railway stations and airports etc., entrances and exits of ports and harbors etc. and entrances and exits of warehouses, transit centers, transit warehouses etc. The blockchain can be a private chain or an alliance chain; it can also be a public chain. Some appropriately distributed nodes are full nodes with complete data and functions, other nodes are SPV (simple payment verification) nodes with block headers.

Newly acquired data including the ID of the RFID tag, the position (position of the RFID reader acquiring the data), the time at which data are acquired and other available data stored in the RFID tag are encrypted asymmetrically, verified by a full node assigned in turn according to some assignment rules for bookkeeping rights and packaged into a block with other verified data sets acquired in the same period of time; the block is then written to the blockchain by the assigned full node, broadcast and synchronized among all the nodes, thus increasing the data processing speed and efficiency substantially. Consensus algorithms like PoW (proof of work), PoS (proof of stake) and DPoS (delegated proof of stake) etc. can be used to obtain bookkeeping rights for full nodes, especially in public RFID reader blockchains. Data acquired by RFID readers include the ID and other available data stored in the RFID tag, the time at which data are acquired and the position of the RFID reader to form a dataset.

Data verification include the validity or legitimacy of the RFID reader, the validity or legitimacy of the RFID tag and whether the goods with the RFID tag is manufactured by a legitimate manufacturer etc., it can also include verification on whether the pharmaceutical product or food with the RFID tag is produced under a certification of FDA (food and drug administration) with a certification number in order to avoid drug and/or food without FDA certification entering the drug and/or food circulation system or supply chain for a safer drug and/or food circulation. Owing to the adoption of the blockchain technology, data are encrypted asymmetrically, verified, written into a blockchain incorrigibly and copy-stored in all full nodes, and are therefore confidential, safe and incorrigible.

### DETAILED DESCRIPTION OF THE INVENTION

In one embodiment of the present invention, an RFID reader blockchain can be constructed according to the EPC (electronic product Code) Global Network standard. The RFID reader blockchain can be a private chain, an alliance chain or a public chain with full nodes and SPV nodes. RFID readers can be multi-channel high through-put readers detecting large number of RFID tags on goods passing through at the same time.

In one embodiment of the present invention, 5G compatible RFID readers are connected to nodes of a blockchain connected with 5G wireless communication technology to form a 5G RFID reader blockchain, which can be a private chain, an alliance chain or a public chain with full nodes and SPV nodes. In another embodiment, an RFID reader blockchain can be built on a wired and wireless combined network.

In one embodiment of the present invention, bookkeeping rights are assigned to full nodes in turn according to some assignment rule or sequence; no need for consensus process and/or consensus algorithms; or in other words, the consensus algorithm is assignment of bookkeeping rights to full nodes in turn; and thus the structure of the block header can be simplified and data processing speed can be increased. In another embodiment, since the datasets acquired by RFID readers have a time stamp and positions of the RFID readers; and the same RFID tag cannot be at different positions at the same time; different blocks written at the same period of time by different nearby full nodes are allowed to co-exist and synchronized in the chain; removing the need for consensus process and increasing substantially the data processing speed. Of course, consensus process with consensus algorithm like the POW, POS or others can be introduced for bookkeeping rights assignment at the sacrifice of data processing speed.

In one embodiment of the present invention, RFID reader blockchain can be used for the safe supply chain circulation of drugs and pharmaceutical products. Pharmaceutical products of regular manufacturers are assigned IDs (identification numbers) with special digital blocks belonging to the manufacturer and/or belonging to the product and tracked through a RFID reader blockchain to form electronic circulation tracking record for every item of pharmaceutical products. Illegal RFID tags with illegal RFID IDs or dispatched with the wrong manufacturer or consigner address are rejected during the verification process and are not allowed to enter the blockchain, thus excluded from the safe supply chain circulation of pharmaceutical products. Verification of FDA certification can also be devised for datasets acquired before packaged and written to the blockchain to exclude products without an FDA certification. Likewise, RFID reader blockchain can be used for the safe supply chain circulation of foods and/or other goods, merchandises or commodities. A safe supply circulation system for goods, merchandises or commodities can be established through the RFID reader blockchain disclosed in the present invention.

In one embodiment of the present invention, RFID reader blockchain can be applied to self-coordination or cooperation of supply chain. Relevant parties involved in a supply chain include raw materials suppliers, manufacturers, processing factories, wholesalers, logistics operators, supply chain financial service providers, retailers and customers etc. The contracts of relevant parties can be embedded in the blockchain in the form of smart (intelligent) contracts and executed automatically through activation and/or actuation by pre-set conditions with full tracking records; thus increasing reliability, safety and coordination and/or cooperation efficiency of supply chain cooperation.

In one embodiment of the present invention, RFID reader blockchain can issue chain currency (coin) or token to provide convenience for the execution of smart contracts and to provide certain kind of encouragement and/or inspiration for participation in the chain. Part of the issued chain currency or token can be used as stakes of the RFID reader blockchain, and part of the issued chain currency or token can be used as encouragement, e.g. RFID reader and/or nodes in the chain can be rewarded with chain currency or token according to their work in the chain. The chain currency or token can be circulated in the chain through smart contracts and/or through payment and transfer etc.

The above technical schemes or embodiments of the present invention include the best technical shceme of the present invention; but the present invention also include various variants of the above technical schemes or embodiments according to the creative thoughts of the present invention. For example, datasets acquired by RFID readers can be asymmetrically encrypted, verified, packaged into a block and written to the chain by nearby full nodes, by full nodes assigned in turn according to some rules or by full nodes which succeed in the bookkeeping competition with the POW, POS or POW/POS combined algorithms. Bookkeeping rights can also be obtained by full nodes through voting in the chain. Bookkeeping full nodes are also rewarded with chain currency or token according certain rules. For another example, an RFID reader blockchain can be constructed on a 5G or other wireless communication network or on a wired and wireless combined network. For example again, an RFID reader blockchain is a P2P (peer to peer) distributed network system, but the information system built on top of the chain can be a cloud computing A/S (Apps/Server) system, B/S (Browser/Server) system or C/S (Client/Server) system; and it can also be an improved P2P distributed system with some full nodes as centers.

The present invention discloses an RFID reader blockchain for an IOT for goods to increase the safety, confidentiality and incorrigibility of data during data acquisition, processing and transmission. The blockchain can be used for safe drug and food supply circulation system and supply chain cooperation systems.

### DETAILED EMBODIMENT

Further description of the present invention is made in the following section with two preferred embodiments.

Preferred Embodiment One: In this preferred embodiment, sufficient RFID readers are installed at various entrances and exits where goods pass including entrances and exits of roads, highways and expressways etc., entrances and exits of truck stations, railway stations and airports etc., entrances and exits of ports and harbors etc. and entrances and exits of warehouses, transit centers, transit warehouses etc. to track goods and cargoes with RFID tags. The RFID readers are connected to the nodes of a P2P distributed blockchain network to form an RFID reader blockchain to increase the safety, confidentiality and incorrigibility of data during data acquisition, processing and transmission. The RFID reader blockchain forms an IOT (Internet Of Things) for goods, merchandises and commodities by tracking RFID tags embedded in them. The blockchain is an alliance chain. Some appropriately distributed nodes are full nodes with complete data and functions, other nodes are SPV (simple payment verification) nodes with block headers.

Newly acquired dataset including RFID, position (position of the RFID reader acquiring the data), time at which data are acquired and other available data stored in the RFID tag is encrypted asymmetrically, verified by a full node assigned in turn according to some assignment rules for bookkeeping rights and packaged into a block with other verified data sets acquired in the same period of time; the block is then written to the blockchain by the assigned full node, broadcast and synchronized among all the nodes in the blockchain, thus increasing the data processing speed and efficiency substantially. Data acquired by RFID readers include the ID and other available data stored in the RFID tag, the time at which data are acquired and the position of the RFID reader to form a dataset.

Data verification include the validity of the RFID reader, the validity of the RFID tag and whether the goods with the RFID tag is manufactured by a legitimate manufacturer etc., it can also include verification on whether the pharmaceutical product or food with the RFID tag is produced under a certification of FDA (food and drug administration) with a certification number in order to avoid drug without FDA certification entering the drug and/or food circulation system or supply chain for a safer drug and/or food circulation. Owing to the adoption of the blockchain technology, data are encrypted asymmetrically, verified, written into a blockchain incorrigibly and copy-stored in all full nodes, and are therefore confidential, safer and incorrigible.

Preferred Embodiment Two: In this preferred embodiment two, sufficient RFID readers compatible with 5G wireless communication technology are installed at various entrances and exits where goods pass including entrances and exits of roads, highways and expressways etc., entrances and exits of truck stations, railway stations and airports etc., entrances and exits of ports and harbors etc. and entrances and exits of warehouses, transit centers, transit warehouses etc. to track goods and cargoes with RFID tags. The 5G compatible RFID readers are connected to the nodes of a P2P distributed blockchain network based on 5G wireless communication technology to form a 5G RFID reader blockchain to increase the safety, confidentiality and incorrigibility of data during data acquisition, processing and transmission. The 5G RFID reader blockchain is also compliant with the EPC Global Network standards. The RFID reader blockchain forms an IOT (Internet Of Things) for goods, merchandises and commodities by tracking RFID tags embedded in them. The blockchain is a private chain. Some appropriately distributed nodes are full nodes with complete data and functions, other nodes are SPV (simple payment verification) nodes with block headers.

Newly acquired data set including RFID, position (position of the RFID reader acquiring the data), timing and other available data stored in the RFID tag is encrypted asymmetrically, verified by a full node with bookkeeping rights obtained through a POW algorithm and packaged into a block with other verified datasets acquired in the same period of time; the block is then written to the blockchain by the full node, broadcast and synchronized among all the nodes. Data acquired by RFID readers include the ID and other available data stored in the RFID tag, the time at which data are acquired and the position of the RFID reader to form a dataset.

Data verification include the validity of the RFID reader, the validity of the RFID tag and whether the goods with the RFID tag is manufactured by a regular manufacturer etc., it can also include verification on whether the pharmaceutical product or food with the RFID tag is produced under a certification of FDA (food and drug administration) with a certification number in order to avoid drug without FDA certification entering the drug circulation system or supply chain for a safer drug circulation. Owing to the adoption of the blockchain technology, data are encrypted asymmetrically, verified, written into a blockchain incorrigibly and copy-stored in all full nodes, and are therefore confidential, safer and incorrigible.

The RFID reader blockchain issues an RFID chain currency, i.e. RFID Coin, 50% of the issued RFID Coins are used as stakes of the RFID reader blockchain, 30% are used for initial coin offering, the other 20% are used as rewards to full nodes according to the amount of bookkeeping work done.

The present invention can be employed in any general purpose or special purpose computing environments or computing systems. Examples of applicable known computing systems, computing environments and/or computing configurations for the present invention include, but not limited to, personal computer, server computer, special purpose computers, portable or laptop equipment, handsets, smart devices, multiple processor systems, systems based on micro-processors, set top box, programmable consumer electronic appliances, network personal computers, small computers, large scale computers, cloud computing systems (A/S: App/Server), B/S systems, C/S systems and distributed computing environments which contain any systems and/or equipments described above, etc.

The embodiments above are examples provided for technicians in the field to realize the present invention. Technicians in the field can make changes or modifications to the embodiments described above in accordance with the creative thoughts of the present invention. Therefore the scope of the present invention will not be limited by the above embodiments, but will be extended to the maximum extent in accordance with the creative characteristics put forward in the claims. The present invention claims all the claims presented in the Claims section that follows.

1. A goods IOT based on blockchain, comprising:
RFID readers installed at places or entrances and exits where goods pass are connected to nodes of a blockchain to form an RFID reader blockchain;
acquiring data from passing goods with RFID tags.

2. The goods IOT of claim 1, wherein the entrances and exits where goods pass refer to some of entrances and exits for roads, highways and expressways etc., entrances and exits of truck stations, railway stations and airports etc., entrances and exits of harbours and ports etc. and entrances and exits of warehouses, transit centers and transit warehouses etc. where goods pass.

3. The goods IOT of claim 1, wherein acquired data by RFID readers are asymmetrically encrypted and then verified by full nodes assigned in turn according to certain sequence or by nearby full nodes; packaged into a block with other data processed in the same period of time, written to the blockchain and synchronized in the blockchain if verified, and discarded if not verified.

4. The goods IOT of claim 1, wherein the data acquired include the ID and other data stored in the RFID tag if available, the time of data acquisition and the position of the RFID reader acquiring the data to form a dataset.

5. The goods IOT of claim 3, wherein the verification includes one or several of the verifications of the legitimacy of the RFID reader, the legitimacy of the RFID tag and whether the goods with the RFID tag is a product of a legitimate manufacturer etc., and especially the verification whether the drug with the RFID tag is manufactured with an FDA certification for a safe drug supply circulation system.

6. The goods IOT of claim 1, wherein the RFID reader blockchain can issue chain currency, coins or token to facilitate the execution of smart contracts and encouragement of participation in the bookkeeping work of the blockchain by full nodes.

7. The goods IOT of claim 1, wherein bookkeeping rights can also be obtained by full nodes through consensus process with consensus algorithm like POW, POS or POW/POS combined algorithms and through voting by nodes.

8. The goods IOT of claim 1, wherein the IOT can be used for the construction of safe and reliable supply circulation systems for drugs, pharmaceutical products and foods or for general goods, merchandises and commodities, which exclude fake products from the system.

9. The goods IOT of claim 1, wherein the IOT can be used for the construction of safe, reliable and efficient supply chain cooperation systems; contracts can be embedded in the blockchain in the form of smart contracts and automatically executed with activation or actuation by certain conditions set in the smart contract with complete tractable records.

10. A system upon a goods IOT based on blockchain, comprising:
RFID readers installed at places or entrances and exits where goods pass are connected to nodes of a blockchain to form an RFID reader blockchain;
acquiring data from passing goods with RFID tags.

11. The system of claim 10, wherein the entrances and exits where goods pass refer to some of entrances and exits for roads, highways and expressways etc., entrances and exits of truck stations, railway stations and airports etc., entrances and exits of harbours and ports etc. and entrances and exits of warehouses, transit centers and transit warehouses etc. where goods pass.

12. The system of claim 10, wherein acquired data by RFID readers are asymmetrically encrypted and then verified by full nodes assigned in turn according to certain sequences or by nearby full nodes; packaged into a block with other data processed in the same period of time, written to the blockchain and synchronized in the blockchain if verified, and discarded if not verified.

13. The system of claim 10, wherein the data acquired include the ID and other data stored in the RFID tag if available, the time of acquisition and the position of the RFID reader acquiring the data to form a dataset.

14. The system of claim 12, wherein, wherein the verification includes one or several of the verifications of the legitimacy of the RFID reader, the legitimacy of the RFID tag and whether the goods with the RFID tag is a product of a legitimate manufacturer etc., and especially the verification whether the drug with the RFID tag is manufactured with an FDA certification for a safe drug supply circulation system.

15. The system of claim 10, wherein the RFID reader blockchain can issue chain currency, coins or token to facilitate the execution of smart contracts and encouragement of participation in the bookkeeping work of the blockchain by full nodes.

16. The system of claim 10, wherein bookkeeping rights can also be obtained by full nodes through consensus process with consensus algorithm like POW, POS or POW/POS combined algorithms or through voting by nodes.

17. The system of claim 10, wherein the IOT can be used for the construction of safe and reliable supply circulation systems for drugs, pharmaceutical products and foods or for general goods, merchandises and commodities, which exclude fake products from the system.

18. The system of claim 10, wherein the IOT can be used for the construction of safe, reliable and efficient supply chain cooperation systems; contracts can be embedded in the blockchain in the form of smart contracts and automatically executed with activation or actuation by certain conditions set in the smart contract with complete tractable records.
